(19) United States
(12) Patent Application Publication
(10) Pub. No.: US 2022/0023675 A1
(43) Pub. Date: Jan. 27, 2022

(54) POWERED AIR-PURIFYING RESPIRATOR ASSEMBLY AND MANUFACTURING METHOD

(71) Applicant: Ford Global Technologies, LLC, Dearborn, MI (US)

(72) Inventors: Jennifer A. Herr-Rathke, Plymouth, MI (US); Jeffrey Paul Luther, Saline, MI (US); Martin P. Smets, Lasalle (CA); Michael Medoro, Sunnyvale, CA (US)

(21) Appl. No.: 16/936,994

(22) Filed: Jul. 23, 2020

(51) Int. Cl. A62B 18/00; A62B 7/12; A62B 7/10

(52) U.S. Cl. CPC A62B 18/006; A62B 7/10; A62B 7/12

(57) ABSTRACT

A powered air-purifying respirator (PAPR) assembly includes, among other things, a tube extending from a filtration unit to a headpiece system. The tube is biased toward a looped position where the tube includes a loop. A PAPR manufacturing method includes, among other things, reorienting a tube to have a loop by placing the tube about a mandrel, heat-treating the tube, and removing the mandrel from the tube. The tube is biased toward a looped position after the removing due to the heat-treating while the tube is reoriented to have the loop.

### TECHNICAL FIELD

This disclosure relates generally to a powered air-purifying respirator having a tube biased toward a looped position and a method of manufacturing the same.

### BACKGROUND

A powered air-purifying respirator (PAPR) is a type of personal protective equipment. A PAPR can include a blower that forces air through filter cartridges or canisters and into a breathing zone of a wearer. This provides the wearer with a filtered airflow inside, for example, a tight-fitting headpiece or loose-fitting hood or helmet. A PAPR can protect the wearer from breathing in particulates, gases, and vapors.

### SUMMARY

A powered air-purifying respirator (PAPR) assembly according to an exemplary aspect of the present disclosure includes, among other things, a tube extending from a filtration unit to a headpiece system. The tube is biased toward a looped position where the tube includes a loop.

Another example of the foregoing assembly includes the filtration unit and the headpiece system.

In another example of any of the foregoing assemblies, the headpiece system includes a hood and a mask.

Another example of any of the foregoing assemblies includes a blower of the filtration unit that forces air through a least one filter of the filtration unit and into the tube.

In another example of any of the foregoing assemblies, the tube is thermal formed when the tube is disposed about a mandrel.

In another example of any of the foregoing assemblies, the tube is polyethylene.

In another example of any of the foregoing assemblies, the tube lacks a metal or metal alloy helix reinforcement.

In another example of any of the foregoing assemblies, the tube is blow molded.

In another example of any of the foregoing assemblies, a first end portion of the tube is connected to the filtration unit and an opposite, second end portion of the tube is connected to the headpiece system.

In another example of any of the foregoing assemblies, the tube is biased toward the looped position such that a size of the loop decreases when the first end portion is moved away from the second end portion, and the size of the loop increases when the first end portion is moved toward the second end portion.

In another example of any of the foregoing assemblies, the loop extends from a first portion of the tube that connects to the filtration unit to a second portion of the tube that connects to the headpiece system.

In another example of any of the foregoing assemblies, when the PAPR assembly is worn by a user, the loop curves laterally outward and upward from the first portion to a first side of the user, and curves laterally outward and downward from the second portion to the first side of the user.

A powered air-purifying respirator (PAPR) manufacturing method according to another exemplary aspect of the present disclosure includes, among other things, reorienting a tube to have a loop by placing the tube about a mandrel, thermal forming the tube, and removing the mandrel from the tube. The tube is biased toward a looped position after the removing due to the heat-treating while the tube is reoriented to have the loop.

Another example of the foregoing method includes connecting a first end portion of a tube to a filtration unit, and connecting an opposite, second end portion of the tube to a headpiece system.

Another example of any of the foregoing methods, includes blow-molding the tube prior to the reorienting.

A powered air-purifying respirator (PAPR) manufacturing method according to yet another exemplary aspect of the present disclosure includes, among other things, connecting a first end portion of a tube to a filtration unit, and connecting an opposite, second end portion of the tube to a headpiece system. The tube is biased toward a looped position.

Another example of the foregoing method includes communicating air through the tube from the filtration unit to the headpiece system.

Another example of any of the foregoing methods includes, prior to the connecting, reorienting a tube to have a loop by placing the tube about a mandrel and then heat-treating the tube.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective and partially schematic view of a powered air-purifying respirator (PAPR) according to an exemplary aspect of the present disclosure.

FIG. 2 illustrates the PAPR of FIG. 1 worn by a user.

FIG. 3 illustrates a tube from the PAPR of FIG. 1.

FIG. 4 illustrates the tube of FIG. 2 prior to the tube being positioned about a mandrel and thermal formed.

FIG. 5 illustrates the PAPR of FIG. 1 worn by a user of above average stature.

FIG. 6 illustrates the PAPR of FIG. 1 worn by a user of average stature.

FIG. 7 illustrates the PAPR of FIG. 1 worn by a user of below average stature.

FIG. 8 illustrates the PAPR of FIG. 1 worn by the user of above average stature of FIG. 5 when the user is bent over.

### DETAILED DESCRIPTION

This disclosure details a powered air-purifying respirator (PAPR). A tube of the PAPR is biased to a looped position. The tube is long enough for the PAPR to be worn by a taller user and for the taller user to bend over at the waist, for example, when wearing the PAPR.

The PAPR can instead be worn by a short statured user. A loop in the tube is larger when the PAPR is worn by the shorter user than when the PAPR is worn by the tall statured user. The biasing of the tube to the looped position helps to keep the loop from interfering with the shorter user.

The PAPR can be used by the taller user or instead used by the shorter user. Using the same PAPR design for taller and shorter users can, among other things, reduce design complexity and costs.

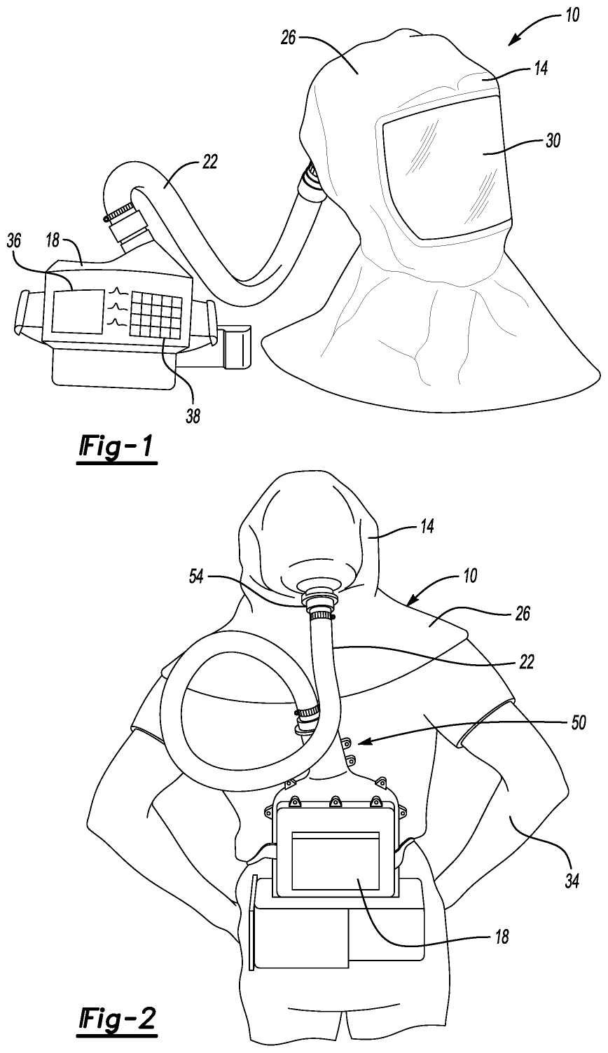

With reference to FIGS. 1-3, a PAPR assembly 10 according to an exemplary embodiment of the present disclosure, includes a headpiece system 14, a filtration unit 18, and a tube 22.

In the exemplary embodiment, the headpiece system 14 includes a hood 26 and a mask 30. When a user 34 is wearing the PAPR 10, the headpiece system 14 fits over a head of the user 34, and the filtration unit 18 is secured about the waist of the user 34.

As schematically shown in FIG. 1, the filtration unit 18 includes a blower 36 and at least one filter 38. The blower 36 forces air through the filter 38 into the tube 22. The filter 38 filters the air.

The tube 22 extends between the headpiece system 14 and the filtration unit 18. The tube 22 delivers filtered air from the filtration unit 18 to the headpiece system 14. The air moves from the tube 22 into a breathing zone of the user 34. The breathing zone is beneath the headpiece system 14. The user 34 can thus breathe air filtered by the filter of the filtration unit 18.

The tube 22 extends from a first end portion 50 to a second end portion 54. In the exemplary embodiment, the first end portion 50 is configured to engage with the filtration unit 18, and the second end portion 54 is configured to engage with the headpiece system 14.

As shown, a pipe clamp can be used to secure the first end portion 50 to a coupling that operably couples the tube 22 to the filtration unit 18. Another pipe clamp can be used to secure the second end portion 54 to a coupling that operably couples the tube 22 to a spigot of the headpiece system 14 that extends from a back of the hood 26.

In FIGS. 2 and 3, the tube 22 is in a looped position. In the looped position, the tube 22 includes a loop 58 between the first end portion 50 and the second end portion 54. In the example of FIG. 3, the loop 58 has a diameter D.

The loop 58 curves laterally outward and upward to a left-hand side of the user 34 from the first end portion 50 of the tube 22. The loop 58 curves laterally outward and downward from the second end portion 54 of the tube 22 to the left-hand side of the user U_{A}.

Notably, the tube 22 is biased toward the looped position shown in FIGS. 2-3. The tube 22 is a resilient tube that, absent external forces, returns to the looped position after being moved from the looped position.

As can be appreciated, stretching the tube 22 such that the first end portion 50 and the second end portion 54 move further apart from one another along an axis A causes the size of the loop 58 to decrease. That is, the diameter D of the loop decreases as the first end portion 50 and the second end portion 54 of the tube 22 are moved further apart along the axis A.

The tube 22 being biased toward the looped position of FIG. 3 means, for purposes of this disclosure, that the tube 22 returns to the looped position of FIG. 3 unless forces on the tube 22 prevent movement of the tube 22 into the looped position.

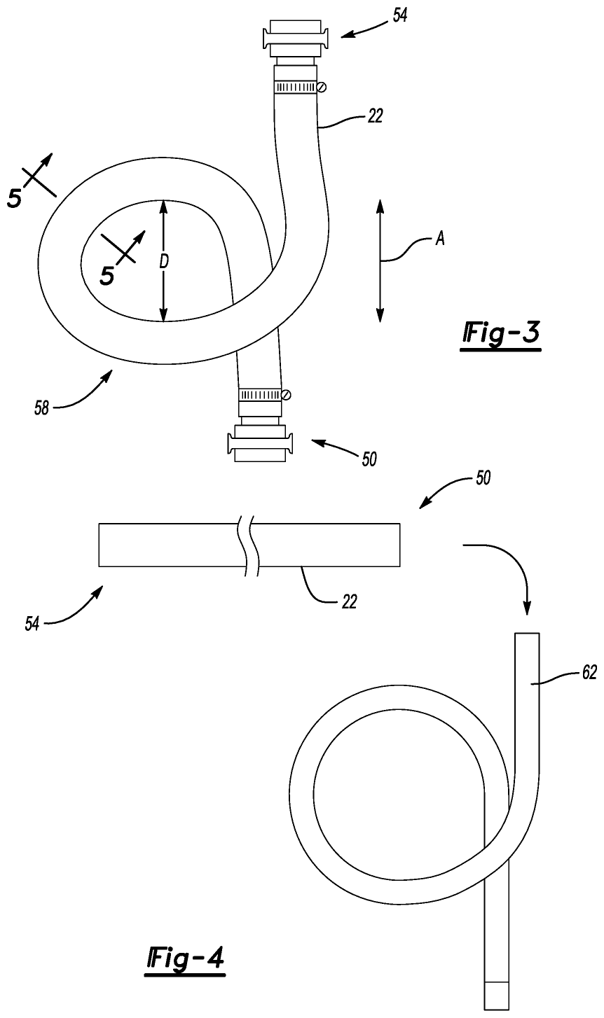

With reference now to FIG. 4 and continuing reference to FIG. 3, in the exemplary embodiment, the tube 22 is blow-molded. The tube 22 is then thermal-formed or heat-treated as a secondary operation. The tube 22 is thus a heat-treated tube. A person having skill in this art and the benefit of this disclosure would understand how to structurally distinguish a heat-treated tube from a tube that is not thermal formed or heat treated.

In particular, after blow-molding, the tube 22 is sleeved over a mandrel 62 to position the tube 22 about the mandrel 62. The mandrel 62 can be a metal or metal alloy. Positioning the tube 22 about the mandrel 62 forces the tube 22 into the looped position.

The heat-treatment of the tube 22 involves, in the exemplary embodiment, heating the tube 22 while the tube 22 is about the mandrel 62 and then permitting the tube 22 to cool while the tube 22 is about the mandrel 62. The shape of the mandrel 62 helps to hold the tube 22 in the looped position during the heating and cooling. The forming of the tube 22 can be considered a thermal forming process or a curing process. In another example, the forming of the tube 22 can be considered an annealing or tempering process.

Heating and cooling while the tube 22 is in the looped position alters the molecular structure of the tube 22 and causes the tube 22 to be biased toward the looped position. That is, after the heating and cooling of the tube 22 in the looped position, the tube 22 will resiliently spring back or return to the looped position when removed from the mandrel 62.

Other methods of biasing the tube 22 toward the looped position of FIG. 2 could be utilized in other examples. For example, the tube 22 could be injection molded into the shape of FIG. 2, which can cause the tube 22 to be biased toward the looped position of FIG. 2.

The tube 22 is polyethylene in the exemplary embodiment, but other materials could be used. The tube 22 has annular corrugations about its longitudinal length.

Notably, the example tube 22 lacks any sort of metal or metal alloy reinforcement extending along a longitudinal length of the tube 22. That is, an axial cross-section through the tube 22 at line S-S in FIG. 3 would not extend through any metal or metal alloy material. In the past, the tubes of some PAPRs have included a metal coil reinforcing structure extending along a longitudinal length of the tube to provide the tube with an accordion-style functionality.

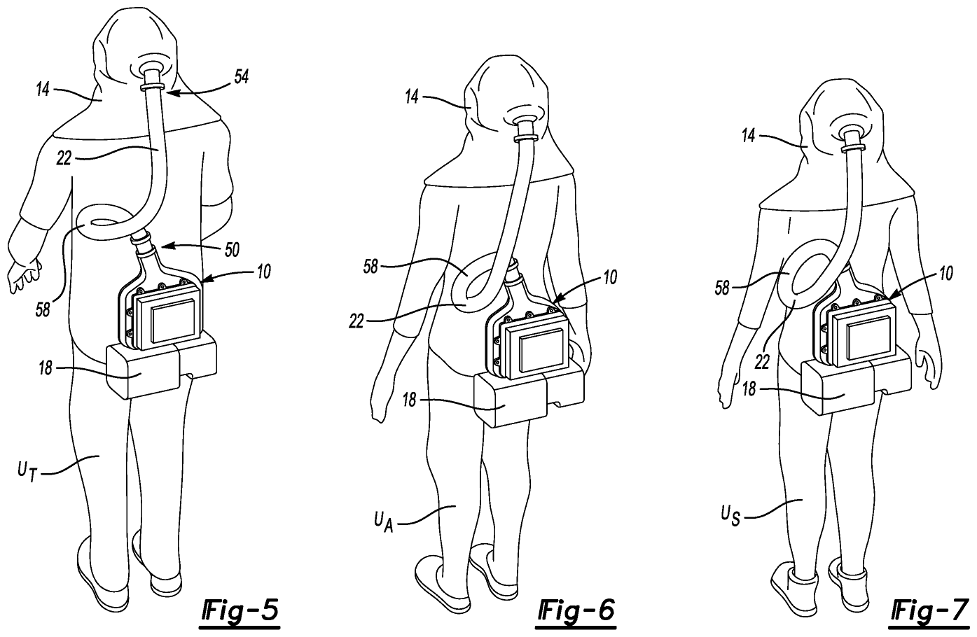

With reference now to FIGS. 5-7, the loop 58 facilitates use of the PAPR 10 by users of various statures. Thus, a first PAPR having a shorter tube and a different, second PAPR having a longer tube is not required to accommodate users of various statures. In the past, PAPRs with longer tubes have been utilized by taller individuals, and PAPRs with shorter tubes have been utilized by shorter individuals. As can be appreciated, offering PAPR variations with both longer and shorter tubes can, among other things, increase complexity and cost.

FIG. 5 shows the PAPR 10 worn by a user U_{T} that is relatively tall. FIG. 6 shows the PAPR 10 worn by a user U_{A} of average stature. FIG. 7 shows the PAPR 10 worn by a user U_{S} that is relatively short.

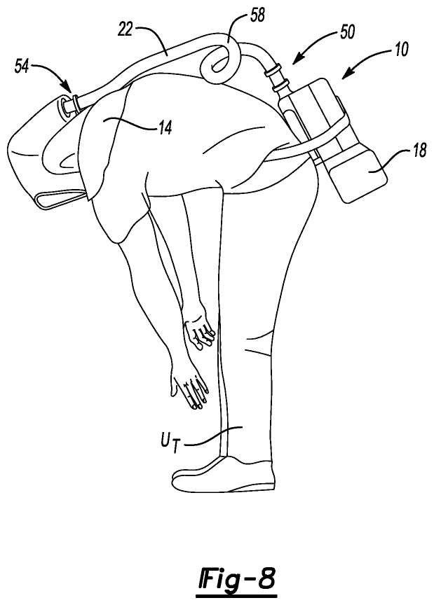

The headpiece system 14 is further from the filtration unit 18 when the user U_{T} wears the PAPR 10 than when the user U_{A} or the user U_{S} wears the PAPR 10. When worn by the user U_{T}, the loop 58 stretches out somewhat to accommodate the greater distance between the first end portion 50 and the second end portion 54 of the tube 22. In the exemplary embodiment, when the user U_{T} is standing straight as shown in FIG. 5, some of the loop 58 remains. This amount of the loop 58 gives the user U_{T} enough slack to bend forward at the waist without the tube 22 restricting such movement (FIG. 8).

Biasing the tube 22 toward the looped position ensures that the loop 58 will be located in an area that will not interfere with the user U_{T}. If the tube 22 were not biased toward the looped position, the tube 22 could protrude and flop into unpredictable positions when worn by the user U_{T}. The tube 22 if not biased to the looped position could potentially interfere with the user U_{T}.

When the user U_{A} wears the PAPR 10, the tube 22 does not need to extend as far as when the PAPR 10 is worn by the user U_{T}. As the tube 22 is biased toward the looped position of FIG. 3, the tube 22 falls into the loop 58 as shown in FIG. 6. The loop 58 of FIG. 6 is larger, i.e., has a larger diameter, than the loop 58 of FIG. 5.

When the PAPR 10 is worn by the user U_{S}, the loop 58 continues to be formed and the diameter D of the loop 58 increases even more from that of the loop 58 in FIGS. 5 and 6. The loop 58, however, maintains its general position in an area that does not interfere with movement of the user U_{S}. Further, the tube 22 being biased toward the looped position where the loop 58 is in a relatively predictable and unobtrusive position can help to avoid the tube 22 getting caught on obstacles, equipment, other individuals, etc.

Notably, the tube 22 can be replace a PAPR tube that is not biased toward a looped position. That is, the tube 22 can be interchangeable with PAPR tubes that are not biased toward a looped position. The interchangeability enables the tube 22 to be retrofitted within existing PAPR assemblies to make those assemblies usable for users of varying statures.

Some features of the disclosed examples include a PAPR that can be worn by relatively tall and relative short individuals without requiring differently sized tubes. The tube can be a fixed length, but meet the full range of user statures and motions, cost targets, mass requirements, and robustness, airflow, and leak requirements.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A powered air-purifying respirator (PAPR) assembly, comprising:
a tube extending from a filtration unit to a headpiece system, the tube biased toward a looped position where the tube includes a loop.

2. The PAPR assembly of claim 1, further comprising the filtration unit and the headpiece system.

3. The PAPR assembly of claim 2, wherein the headpiece system includes a hood and a mask.

4. The PAPR assembly of claim 2, further comprising a blower of the filtration unit that forces air through a least one filter of the filtration unit and into the tube.

5. The PAPR assembly of claim 1, wherein the tube is thermal-formed when the tube is disposed about a mandrel.

6. The PAPR assembly of claim 1, wherein the tube is polyethylene.

7. The PAPR assembly of claim 6, wherein the tube lacks a metal or metal alloy helix reinforcement.

8. The PAPR assembly of claim 1, wherein the tube is blow molded.

9. The PAPR assembly of claim 1, wherein a first end portion of the tube is connected to the filtration unit and an opposite, second end portion of the tube is connected to the headpiece system.

10. The PAPR assembly of claim 9, wherein the tube is biased toward the looped position such that a size of the loop decreases when the first end portion is moved away from the second end portion, and the size of the loop increases when the first end portion is moved toward the second end portion.

11. The PAPR assembly of claim 1, wherein the loop extends from a first portion of the tube that connects to the filtration unit to a second portion of the tube that connects to the headpiece system.

12. The PAPR assembly of claim 11, wherein, when the PAPR assembly is worn by a user, the loop curves laterally outward and upward from the first portion to a first side of the user, and curves laterally outward and downward from the second portion to the first side of the user.

13. A powered air-purifying respirator (PAPR) manufacturing method, comprising:
reorienting a tube to have a loop by placing the tube about a mandrel;
heat-treating the tube; and
removing the mandrel from the tube, the tube biased toward a looped position after the removing due to the heat-treating while the tube is reoriented to have the loop.

14. The PAPR manufacturing method of claim 13, further comprising connecting a first end portion of a tube to a filtration unit, and connecting an opposite, second end portion of the tube to a headpiece system.

15. The PAPR manufacturing method of claim 13, further comprising blowmolding the tube prior to the reorienting.

16. A powered air-purifying respirator (PAPR) manufacturing method, comprising:
connecting a first end portion of a tube to a filtration unit;
connecting an opposite, second end portion of the tube to a headpiece system, the tube biased toward a looped position.

17. The PAPR manufacturing method of claim 16, further comprising communicating air through the tube from the filtration unit to the headpiece system.

18. The PAPR manufacturing method of claim 16, further comprising, prior to the connecting, reorienting a tube to have a loop by placing the tube about a mandrel and then heat-treating the tube.
